(19) United States
(12) Patent Application Publication
(10) Pub. No.: US 2010/0068133 A1
(43) Pub. Date: Mar. 18, 2010

(54) TWO-STAGE REFORMER AND METHOD FOR OPERATING A REFORMER

(75) Inventors: Andreas Lindermeir, Goslar/Oker (DE); Matthias Mueller, Neubrandenburg (DE)

Correspondence Address: FITCH, EVEN, TABIN & FLANNERY, P. O. BOX 18415, WASHINGTON, DC, 20036, US

(73) Assignee: Enerday GmbH, Neubrandenburg (DE)

(21) Appl. No.: 12/595,429

(22) PCT Filed: Apr. 15, 2008
(86) PCT No.: PCT/DE08/00629

§ 371 Date: Nov. 24, 2009

(30) Foreign Application Priority Data
Apr. 18, 2007 (DE) 10 2007 018 311.0

(51) Int. Cl. C01B 3/24; B01J 19/00

(52) U.S. Cl. 423/650; 422/188

(57) ABSTRACT

The invention relates to a reformer for converting fuel and oxidising agent into a reformate, the reformer comprising an oxidising zone to which a mixture of fuel and oxidising agent is supplyable via a first fuel supply and a first oxidising agent supply and an injection and mixture formation zone disposed downstream of the oxidising zone to which further fuel is supplyable via a second fuel supply, a second oxidising agent supply being provided via which further oxidising agent is supplyable to the injection and mixture formation zone. According to the invention it is contemplated that the second oxidising agent supply is, relative to the second fuel supply, arranged so that it generates a barrier oxidising agent cushion in the area in front of the second fuel supply to prevent a heat transfer from the mixture from the oxidising zone to the second fuel supply. The invention further relates to a method for operating such a reformer.

The invention relates to a reformer for converting fuel and oxidising agent into a reformate, said reformer comprising an oxidising zone to which a mixture of fuel and oxidising agent is supplyable via a first fuel supply and a first oxidising agent supply and an injection and mixture formation zone disposed downstream of the oxidising zone to which further fuel is supplyable via a second fuel supply, a second oxidising agent supply being provided via which further oxidising agent is supplyable to the injection and mixture formation zone.

The invention further relates to a method for operating such a reformer.

Generic reformers are often used in connection with an operation of a fuel cell or a fuel cell stack to produce a hydrogen-rich gas mixture, the reformate, and to supply it to the fuel cell or the fuel cell stack. On the basis of electrochemical processes the fuel cell can generate electric energy due to the supply of said hydrogen-rich gas. Such fuel cells are, for example, used in the field of motor vehicles as additional power sources, so-called APUs (auxiliary power units). The reforming process of the reformer for converting fuel and oxidising agent into a reformate may be effected in accordance with various principles. For example, the catalytic reforming is known in which a part of the fuel is oxidised in an exothermal reaction. Further the so-called “steam reforming” for generating a reformate of hydrocarbons is known. Here hydrocarbons are converted into hydrogen with the aid of steam in an endothermal reaction. A combination of the two above principles, i.e. a reforming on the basis of an exothermal reaction and the generation of hydrogen by an endothermal reaction in which the energy for the steam reforming is obtained by the combustion of the hydrocarbons, is referred to as an autothermal reforming.

A generic reformer carrying out the autothermal type of reforming is, for example, known from the DE 103 59 205 A1. Said reformer according to the state of the art comprises two fuel supplies and two oxidising agent supplies, respectively one of said two supplies being provided for the oxidising zone and for the injection and mixture formation zone. In this way a clear homogenisation of the temperature profile in the reformer and therefore an improvement of the reformer behaviour are achieved. In this known reformer thus first a fuel and an oxidising agent which is usually air are supplied to the oxidising zone of the reformer in which a part of the fuel completely oxidises with the oxidising agent. Due to the oxidation a gaseous oxidation product is generated which will be referred to as a so-called smoke gas below. Said smoke gas then enters the injection and mixture formation zone of the reformer provided downstream of the oxidising zone in which further fuel is newly supplied via a second fuel supply. Thus a further fuel evaporation takes place in the injection and mixture formation zone so that the under-stoichiometric fuel/air ratio required for reforming is realised in the present mixture. Said mixture is then supplied to a reforming zone which may, for example, be at least partly formed by a catalytic converter of the reformer. According to the DE 103 59 205 A1 a second oxidising agent supply is also provided via which further oxidising agent is supplyable to the injection and mixture formation zone. Said second oxidising agent supply serves to optimise the reforming processes and presents another parameter influencing the reforming process. However, said reformer according to the DE 103 59 205 A1 has the disadvantage that a considerable amount of heat is transferred to the second fuel supply, particularly to an evaporator fleece of the second fuel supply, by the hot smoke gas in the injection and mixture formation zone. Due to this heat transfer at least partly pre-evaporations of the fuel to be supplied occur in the second fuel supply or a supply line to the second fuel supply. Here said pre-evaporation leads to an uncontrolled bubble formation in the fuel which may lead to a non-uniform, pulsating fuel supply through the second fuel supply. Said non-uniform fuel supply through the second fuel supply again leads to an instable behaviour of the reformer, strong temperature variations as well as a rise in pressure due to an increased soot formation inside of the reformer.

The invention is therefore based on the object to further develop the generic reformer and method for operating such a reformer so that a reforming process control can be made more stable in multi-stage reformers.

The reformer according to the invention is based on the generic state of the art in that the second oxidising agent supply is, relative to the second fuel supply, disposed so that it generates a barrier oxidising agent cushion in the area in front of the second fuel supply to reduce a heat transfer from the mixture from the oxidising zone to the second fuel supply. Using the first and second oxidising agent supplies the oxidising agent is supplied to the corresponding zones of the reformer in stages, in this case in two stages. In this case preferably 80% to 90% of the required total amount of oxidising agent is supplied to the oxidising zone via the first oxidising agent supply. In this way a sufficient lambda or air number of, for example, more than 1.2 is ensured. The remaining amount of oxidising agent, i.e. 10% to 20% of the total amount of oxidising agent, are supplied in the injection and mixture formation zone via the second oxidising agent supply. In this case the second oxidising agent supply is, with respect to the second fuel supply, formed so that the barrier oxidising agent cushion of cool oxidising agent is formed in front of the second fuel supply in the injection and mixture formation zone and that a heat transfer to the second fuel supply through smoke gas is at least reduced thereby. In this way further a heat conduction within the second fuel supply is reduced. Therefore an external and separate cooling device for cooling the second fuel supply can be omitted which is why no additional cooling performance is required. Due to the low air number or the low lambda in the smoke gas or in the mixture from the oxidising zone a cooling of a reforming zone, for example, a catalytic converter forming the reforming zone can be suppressed by means of higher temperatures in a smoke gas flow, for example, by an enhancement of the heat transfer between the smoke gas in the oxidising zone and the catalytic converter forming the reforming zone by means of a wall.

The reformer according to the invention may advantageously be further developed so that the further oxidising agent at least partly contacts the second fuel supply before it is mixed with the mixture from the oxidising zone. This is, for example, realised by the specific arrangement of the second oxidising agent supply relative to the second fuel supply. In particular it may be contemplated that the second oxidising agent supply is formed as a pipe surrounding the second fuel supply.

Further the reformer according to the invention may be designed so that the second fuel supply comprises an evaporator fleece through which the further fuel to be supplied to the injection and mixture formation zone flows. For example, the second fuel supply may, at least partly, be tubular, the evaporator fleece being inserted in the tubular second fuel supply.

Furthermore the reformer according to the invention may be designed so that a heat-transferring relationship exists between the second oxidising agent supply and the second fuel supply so that the further fuel to be supplied via the second fuel supply is already actively cooled by the second oxidising agent supply before it enters the injection and mixture formation zone. Said active cooling may be additionally provided for cooling the second fuel supply to prevent a pre-evaporation of the further fuel to the maximum extent.

In a preferred embodiment the reformer according to the invention may be further developed so that the first and second oxidising agent supplies are coupled to a common oxidising agent line via which the first and second oxidising agent supply are supplied with oxidising agent. In this way a simplification of the two-stage oxidising agent supply of the reformer is made possible. In this case, for example, only a fan may be provided which supplies air as an oxidising agent and provides both oxidising agent supplies with it.

The reformer according to the invention may, in this connection, further be realised so that a respective oxidising agent volume flow towards the first and second oxidising agent supplies is adjustable via a volume flow divider valve provided on the common oxidising agent line. Thus a division of a total amount of the oxidising agent into a volume flow to the first oxidising agent supply and to the second oxidising agent supply is enabled. With a variable control of the volume flow divider valve a specific adjustment of the temperature level in front of the second fuel supply may be effected depending on the corresponding operating state of the reformer. With the oxidising agent supply via the volume flow divider valve further a variable air ratio may be specifically adjusted between the first oxidising agent supply and the second oxidising agent supply in case of air as the oxidising agent without an additional fan being required.

The method according to the invention is based on the generic state of the art in that the second oxidising agent supply generates a barrier oxidising agent cushion in an area in front of the second fuel supply during the oxidising agent supply to reduce a heat transfer from the mixture from the oxidising zone to the second fuel supply. In this way the advantages explained in connection with the reformer according to the invention are achieved in the same or a similar manner so that reference is made to the corresponding explanations given in connection with the reformer according to the invention to avoid repetitions.

The same applies analogously to the following preferred embodiments of the method according to the invention, reference being made to the corresponding explanations given in connection with the reformer according to the invention in this context as well to avoid repetitions.

The method according to the invention can be advantageously further developed so that the further oxidising agent at least partly contacts the second fuel supply before it is mixed with the mixture from the oxidising zone.

The method according to the invention may further be realised so that the further fuel to be supplied to the injection and mixture formation zone flows through an evaporator fleece of the second fuel supply.

The method according to the invention may further be realised so that the further fuel to be supplied to the second fuel supply is already actively cooled by the second oxidising agent supply before it is introduced into the injection and mixture formation zone.

In a preferred embodiment of the method according to the invention it is contemplated that the first and second oxidising agent supplies are supplied with oxidising agent by a common oxidising agent line.

In this connection the method according to the invention can be further developed so that a respective oxidising agent volume flow towards the first and second oxidising agent supplies is adjusted via a volume flow divider valve provided on the common oxidising agent line.

The invention is based on the realisation that in connection with multi-stage, particularly two-stage reformers a pulsating fuel supply can be prevented by a second fuel supply if said second fuel supply is cooled. This may, on the one hand, be achieved by the generation of a barrier oxidising agent cushion with the aid of the second oxidising agent supply specifically oriented relative to the second fuel supply. Alternatively or additionally an active cooling of the second fuel supply can be effected, for example, by means of the second oxidising agent supply; in this case the second oxidising agent supply may be disposed adjacently, in a heat-transferring relation to the second fuel supply. Both cooling concepts can be realised in combination as well as individually.

The invention will now be explained by way of example with the aid of preferred embodiments with reference to the accompanying drawings in which:

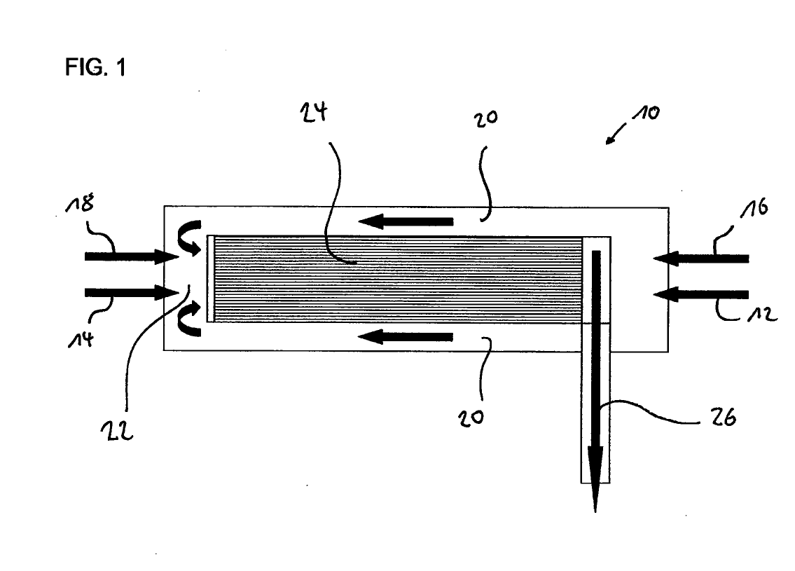

FIG. 1 is a schematic representation of the reformer according to the invention in compliance with a first embodiment of the invention capable of carrying out the method according to the invention; and

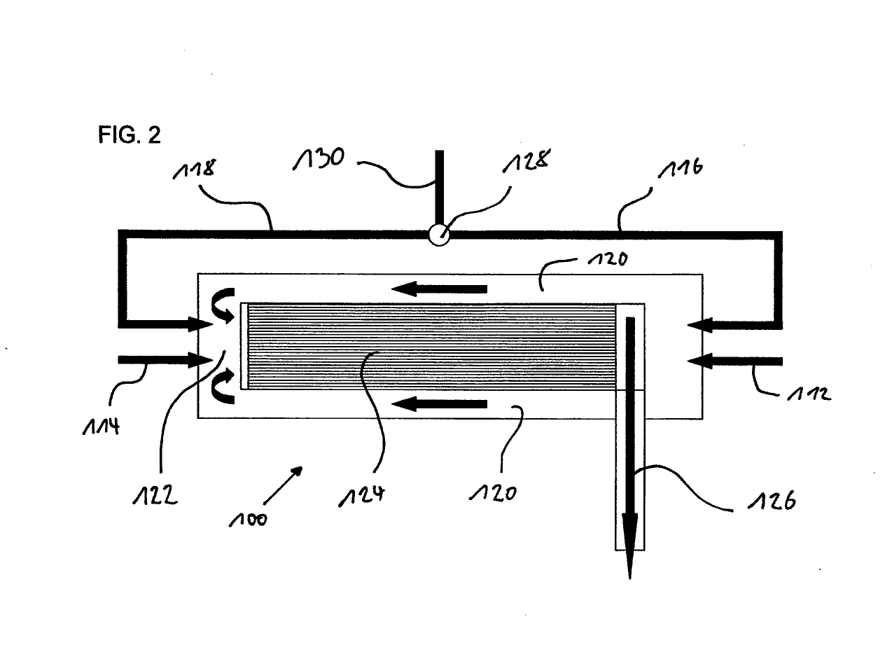

FIG. 2 is a schematic representation of the reformer according to the invention in compliance with a second embodiment of the invention capable of carrying out the method according to the invention.

FIG. 1 shows a schematic representation of a reformer 10 according to the invention according to a first embodiment of the invention capable of carrying out the method according to the invention. The reformer 10 according to the invention comprises an oxidising zone 20 to which fuel and an oxidising agent are supplyable via a first fuel supply 12 and a first oxidising agent supply 16. As fuel, for example, natural gas, diesel fuel or gasoline qualify, the oxidising agent is generally air. Owing to the supply of the fuel and the oxidising agent a mixture is generated which flows into the oxidising zone 20 and is at least partly oxidised there so that a smoke gas can be generated in the oxidising zone 20. In the oxidising zone 20 therefore a conversion of fuel and oxidising agent takes place in an exothermal reaction with an air number of 1 (λ≈1). Thereafter the mixture or the smoke gas enters or flows into an injection and mixture formation zone 22 provided downstream of the oxidising zone 20. In the injection and mixture formation zone 22 a second fuel supply 14 and a second oxidising agent supply 18 are provided which are respectively capable of supplying further fuel and further oxidising agent into the injection and mixture formation zone 22. The thermal energy of the smoke gas from the oxidising zone 20 can, in this case, contribute to the evaporation of the further fuel from the second fuel supply 14. However, to keep a direct heat transfer to the second fuel supply 14 via the smoke gas as low as possible the second oxidising agent supply 18 is arranged so that a barrier oxidising agent cushion is formed in the area in front of the second fuel supply 14 during an oxidising agent supply. In this way a heat transfer from the mixture from the oxidising zone 20 or the smoke gas to the second fuel supply 14 is reduced. In particular it is contemplated that in the present embodiment the oxidising agent supplied by the second oxidising agent supply 18 at least partly contacts the second fuel supply before it is mixed with the mixture or the smoke gas from the oxidising zone 20. In addition an active cooling of the second fuel supply 14 may be carried out by the second oxidising agent supply 18 by establishing a heat-transferring relationship between the second fuel supply 14 and the second oxidising agent supply 18. In particular the second fuel supply 14 may be formed as a pipe concentrically arranged inside of the pipe forming the second oxidising agent supply 18. Thus an active cooling of the second fuel supply 14 and the fuel to be supplied through it does already take place before the further fuel is introduced into the injection and mixture formation zone 22 via the second oxidising agent supply 18. The gas mixture formed in the injection and mixture formation zone 22 then enters a reforming zone provided downstream of the injection and mixture formation zone 22 which is at least partly formed by a catalytic converter 24. There the gas mixture is converted into a reformate 26 in an endothermal reaction with, for example, λ≈0.4. Thereafter the generated reformate 26 flows out of the catalytic converter 24 via a reformer outlet. The reforming zone 24 and the oxidising zone 20 may, in this case, be designed so that a heat-transferring relationship exists between them so that the heat required for the endothermal reaction may be drawn from the oxidising zone 20.

The method according to the invention for operating the reformer 10 according to the invention is as follows. First the fuel and the oxidising agent, in this case air, are supplied to the oxidising zone 20 via the first fuel supply 12 and the first oxidising agent supply 16. In this way a gas mixture is generated which at least partly oxidises to form an oxidised mixture or a smoke gas in the oxidising zone 20. The smoke gas generated in this way then flows from the oxidising zone 20 into the injection and mixture formation zone 22. There further fuel is supplied to the smoke gas via the second fuel duct 14, further oxidising agent being additionally supplied via the second oxidising agent supply 18. Here the further oxidising agent is supplied to the second oxidising agent supply 18 so that the barrier oxidising agent cushion is formed in the area in front of the second fuel supply 14 to reduce the heat transfer from the mixture or the smoke gas from the oxidising zone 20 to the second fuel supply 14. The gas mixture generated in this way then enters the catalytic converter 24 forming the reforming zone where it is converted into a reformate 26 and discharged form the reformer 10 via a reformer outlet.

FIG. 2 shows a schematic representation of a reformer 100 according to the invention according to a second embodiment of the invention. For avoiding repetitions only the differences with respect to the first embodiment are explained in the description of the present embodiment, identical or similar components of the second embodiment being designated by numerals similar to those used for the components of the first embodiment. The second embodiment differs from the first embodiment in that the first and the second oxidising agent supplies 116 and 118 are coupled to a common oxidising agent line 130 via a volume flow divider valve 128. The oxidising agent line 130 is again coupled to an oxidising agent supply device for supplying oxidising agent; if air is used as the oxidising agent the oxidising agent supply device is formed by a fan. With the aid of the volume flow divider valve 128 corresponding volume flows from the first and the second oxidising agent supplies 16 and 18 may be supplied. In this way only one oxidising agent supply device is required which supplies the oxidising agent to the common oxidising agent line 130.

The features of the invention disclosed in the above description, in the drawings as well as in the claims may be important for the realisation of the invention individually as well as in any combination.

### LIST OF NUMERALS

10 reformer
12 first fuel supply
14 second fuel supply
16 first oxidising agent supply
18 second oxidising agent supply
20 oxidising zone
22 injection and mixture formation zone
24 catalytic converter device
26 reformate
100 reformer
112 first fuel supply
114 second fuel supply
116 first oxidising agent supply
118 second oxidising agent supply
120 oxidising zone
122 injection and mixture formation zone
124 catalytic converter device
126 reformate
128 volume flow divider valve
130 oxidising agent line

1. A reformer for converting fuel and oxidising agent into a reformate, said reformer comprising an oxidising zone to which a mixture of fuel and oxidising agent is supplyable via a first fuel supply and a first oxidising agent supply and an injection and mixture formation zone provided downstream the oxidising zone to which further fuel is supplyable via a second fuel supply, a second oxidising agent supply being provided via which further oxidising agent is supplyable to the injection and mixture formation zone, characterised in that the second oxidising agent supply is, relative to the second fuel supply, disposed so that it generates a barrier oxidising agent cushion in the area in front of the second fuel supply to reduce a heat transfer from the mixture from the oxidising zone to the second fuel supply.

2. The reformer of claim 1, characterised in that the further oxidising agent at least partly contacts the second fuel supply before it is mixed with the mixture from the oxidising zone.

3. The reformer of claim 1, characterised in that the second fuel supply comprises an evaporator fleece through which the further fuel to be supplied to the injection and mixture formation zone flows.

4. The reformer of claim 1, characterised in that a heat-transferring relationship exists between the second oxidising agent supply and the second fuel supply so that the further fuel to be supplied via the second fuel supply is already actively cooled by the second oxidising agent supply before entering the injection and mixture formation zone.

5. The reformer of claim 1, characterised in that the first and the second oxidising agent supplies are coupled to a common oxidising agent line via which the first and the second oxidising agent supplies are supplied with oxidising agent.

6. The reformer of claim 5, characterised in that a respective oxidising agent volume flow to the first and the second oxidising agent supplies is adjustable via a volume flow divider valve provided on the common oxidising agent line.

7. A method for operating a reformer for converting fuel and oxidising agent into a reformate, the reformer comprising an oxidising zone, to which a mixture of a fuel and an oxidising agent is supplyable via a first fuel supply and a first oxidising agent supply and an injection and mixture formation zone disposed downstream of the oxidising zone to which further fuel is supplyable via a second fuel supply, a second oxidising agent supply being provided via which further oxidising agent is supplyable to the injection and mixture formation zone, characterised in that the second oxidising agent supply generates a barrier oxidising agent cushion in the area in front of the second fuel supply during the oxidising agent supply to reduce a heat transfer from the mixture from the oxidising zone to the second fuel supply.

8. The method of claim 7, characterised in that the further oxidising agent at least partly contacts the second fuel supply before it is mixed with the mixture from the oxidising zone.

9. The method of claim 7 or 8, characterised in that the further fuel to be supplied to the injection and mixture formation zone flows through an evaporator fleece of the second fuel supply.

10. The method of claim 7, characterised in that the further fuel to be supplied via the second fuel supply is already actively cooled by the second oxidising agent supply before entering the injection and mixture formation zone.

11. The method of claim 7, characterised in that the first and second oxidising agent supplies are supplied with oxidising agent from a common oxidising agent line.

12. The method of claim 11, characterised in that a respective oxidising agent volume flow to the first and the second oxidising agent supplies is adjusted via a volume flow divider valve provided on the oxidising agent line.
